(19) United States
(12) Patent Application Publication
(10) Pub. No.: US 2015/0082346 A1
(43) Pub. Date: Mar. 19, 2015

(54) System for Selective and Intelligent Zooming Function in a Crowd Sourcing Generated Media Stream

(71) Applicant: Nokia Corporation, Espoo (FI)

(72) Inventor: Diego Baldini, Berlin (DE)

(21) Appl. No.: 14/394,049

(22) PCT Filed: Apr. 20, 2012
(86) PCT No.: PCT/CN2012/074455

§ 371 Date: Oct. 10, 2014

(51) Int. Cl. H04N 21/44; H04N 7/18; H04N 7/14; H04N 21/41; H04N 21/4728

(52) U.S. Cl. CPC H04N 21/44; H04N 21/4126; H04N 21/4728; H04N 7/147; H04N 7/181; H04N 2007/145
USPC 725/37

(57) ABSTRACT

An apparatus comprising at least one processor and at least one memory including computer program code may be configured to receive a selection indication from a user of a portion of a composite media content. The apparatus may be configured to cause selection data corresponding to the selection indication to be transmitted. The apparatus may be configured to receive media content providing a different perspective of the portion of the composite media content corresponding to the selection data. Corresponding methods and computer program products are also provided.

### TECHNOLOGICAL FIELD

An example embodiment of the present invention relates generally to media content selection and more particularly, to selecting a portion of a composite media content comprising a plurality of media content and receiving an alternative media content in response to the selection.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Further, mobile terminals now include capabilities to capture media content, such as photographs, video recordings and/or audio recordings. As such, users may now have the ability to record media whenever users have access to an appropriately configured mobile terminal. Accordingly, multiple users may attend an event with each user using a different mobile terminal to capture various media content of the event activities. The captured media content may include redundant content. In addition, some users may capture media content of particular unique portions of the event activity such that each user has a unique perspective and/or view of the event activity. Thereby, the entire library of captured content by multiple users may be compiled to provide a composite media content comprising media captured by different attendees at the particular event activity to provide a more fulsome media content of an event. However, users may desire additional flexibility when viewing composite media content, such as video recordings, that includes portions of media content of the same event captured by a number of different users. Other users may desire to view any media content corresponding to the composite media content. Particularly, users may desire a media content having a particular view, zoom, recording and/or the like in instances in which the composite media content comprises portions of media content captured by users who do not focus on a particular view, zoom, recording and/or the like. Additionally, users may wish additional flexibility when viewing any media content, such as a video recording, that includes portions of additional media content of the same event that may correspond to the original media content, such as a map of the event captured in the original media content, alternative recordings of the event, and/or the like.

### BRIEF SUMMARY

A method, apparatus and computer program product therefore provide for a system for selecting a portion of a composite media content and receiving media content corresponding to the selected portion of the composite media content. In a first example embodiment, an apparatus is provided that includes at least one processor and at least one memory including computer program code with the at least one memory and the computer program code configured to, with the processor, cause the apparatus to receive a selection indication from a user of a portion of a composite media content. The apparatus may be configured to cause selection data corresponding to the selection indication to be transmitted. According to some embodiments, the apparatus may be configured to receive media content providing a different perspective of the portion of the composite media content corresponding to the selection data. In some embodiments, the media content may provide a different perspective, such as a different zoom level, different angle, different view, different temporal position, and/or the like.

In some embodiments, the apparatus may be configured to receive a selection indication from a user of a portion of a composite media content, wherein the composite media content comprises portions of a plurality of user-generated media content. In another embodiment, the apparatus may be configured to receive media content not present in the composite media content. According to another embodiment, the apparatus may be configured to cause selection data corresponding to the selection indication to be transmitted to a composite media content server. In some embodiments, the apparatus may be configured to receive media content providing a different perspective of the portion of the composite media content corresponding to the selection data, wherein the media content includes an audio media content. In another embodiment, the apparatus may be configured to receive media content providing a different perspective of the portion of the composite media content corresponding to the selection data, wherein the media content includes a visual media content.

In another example embodiment, a method may include receiving a selection indication from the user of a portion of a composite media content. The method may comprise causing the selection indication to be transmitted. According to some embodiments, the method may include receiving media content providing a different perspective of the portion of the composite media content corresponding to the selection indication.

In some embodiments, the method may include receiving a selection indication from a user of a portion of a composite media content, wherein the composite media content comprises portions of a plurality of user-generated media content. In another embodiment, the method may comprise receiving media content not present in the composite media content. According to another embodiment, the method may include causing selection data corresponding to the selection indication to be transmitted to a composite media content server. In some embodiments, the method may comprise receiving media content providing a different perspective of the portion of the composite media content corresponding to the selection data, wherein the media content includes an audio media content. In another embodiment, the method may comprise receiving media content providing a different perspective of the portion of the composite media content corresponding to the selection data, wherein the media content includes a visual media content.

In another example embodiment, a computer program product is provided. The computer program product of the example embodiment may include at least one non-transitory computer-readable storage medium having computer-readable program instructions stored therein. The computer-readable program instructions may comprise program instructions configured to cause an apparatus to perform a method comprising receiving a selection indication from the user of a portion of a composite media content. In addition, the program instructions may also be configured to cause an apparatus to perform a method comprising causing selection data corresponding to the selection indication to be transmitted. The program instructions may also be configured to cause an apparatus to perform a method including receiving media content providing a different perspective of the portion of the composite media content corresponding to the selection indication.

In some embodiments, the computer program product may be configured to cause an apparatus to perform a method that includes receiving a selection indication from a user of a portion of a composite media content, wherein the composite media content comprises portions of a plurality of user-generated media content. In another embodiment, the computer program product may be configured to cause an apparatus to perform a method comprising receiving media content not present in the composite media content. According to another embodiment, the computer program product may be configured to cause an apparatus to perform a method including causing selection data corresponding to the selection indication to be transmitted to a composite media content server. In some embodiments, the computer program product may be configured to cause an apparatus to perform a method comprising receiving media content providing a different perspective of the portion of the composite media content corresponding to the selection data, wherein the media content includes an audio media content. In another embodiment, the computer program product may be configured to cause an apparatus to perform a method comprising receiving media content providing a different perspective of the portion of the composite media content corresponding to the selection data, wherein the media content includes a visual media content.

In a further embodiment, an apparatus is provided that includes means for receiving a selection indication from the user of a portion of a composite media content. The apparatus may include means for causing selection data corresponding to the selection indication to be transmitted. According to some embodiments, the apparatus may include means for receiving media content providing a different perspective of the portion of the composite media content corresponding to the selection indication.

In some embodiments, the apparatus may include means for receiving a selection indication from a user of a portion of a composite media content, wherein the composite media content comprises portions of a plurality of user-generated media content. In another embodiment, the apparatus may include means for receiving media content not present in the composite media content. According to another embodiment, the apparatus may include means for causing selection data corresponding to the selection indication to be transmitted to a composite media content server. In some embodiments, the apparatus may include means for receiving media content providing a different perspective of the portion of the composite media content corresponding to the selection data, wherein the media content includes an audio media content. In another embodiment, the apparatus may comprise means for receiving media content providing a different perspective of the portion of the composite media content corresponding to the selection data, wherein the media content includes a visual media content.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described example embodiments of the present disclosure in general terms, reference will now be made to the accompanying drawings, which are not necessarily drawn to scale, and wherein:

FIG. 1 illustrates a schematic representation of a plurality of mobile terminals capturing media content at an event activity according to an example embodiment of the present invention;

FIG. 2 illustrates a schematic block diagram of a mobile terminal according to an example embodiment of the present invention;

FIG. 3 illustrates a schematic block diagram of an apparatus that may be configured to capture user generated media content according to an example embodiment of the present invention;

FIG. 4 illustrates a schematic representation of an event attended by a plurality of users having media capturing devices that illustrates the field of view of the respective users capturing media content;

FIG. 5A illustrates the view from the perspective of a first user of an apparatus according to an example embodiment of the present invention;

FIG. 5B illustrates the view from the perspective of a second user of an apparatus according to an example embodiment of the present invention;

FIG. 5C illustrates the view from the perspective of a third user of an apparatus according to an example embodiment of the present invention;

FIG. 6 illustrates a schematic representation of a composite media content in accordance with an example embodiment of the present invention;

FIG. 7 is a flow chart illustrating operations performed by an apparatus that may include or otherwise be associated with a mobile terminal in accordance with an example embodiment of the present invention; and

FIG. 8 is a flow chart illustrating operations performed by an apparatus that may include or otherwise be associated with a remote computing device, such as a composite media content server, in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

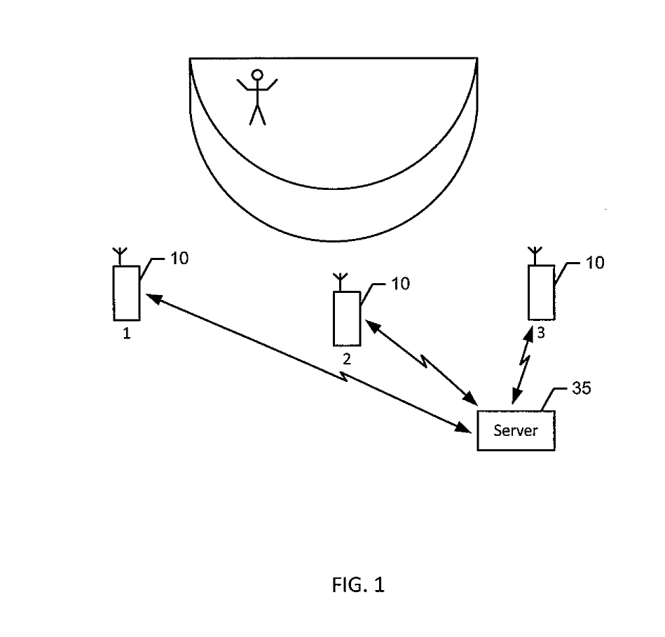

As indicated above, some embodiments of the present invention may be employed in methods, apparatuses and computer program products configured to provide additional media content corresponding to a selection indication of a portion of a composite media content. In this regard, FIG. 1 illustrates a concert where a performer is on stage. The concert of FIG. 1 is only for purposes of example and the method, apparatus and computer program product may also be utilized in conjunction with a number of different types of events including sporting events, plays, musicals, or other types of performances. Regardless of the type of event, a plurality of people may attend the event. As shown in FIG. 1, a number of people who attend the event may each have user equipment, such as the mobile terminal 10 that may include a media capturing module, such as a video camera, for capturing media content, such as video recordings, image recordings, audio recordings and/or the like. Although FIG. 1 illustrates an embodiment of the present invention where mobile terminals are configured to capture media content, one of ordinary skill in the art may appreciate that media content may be captured by any number of devices, including a video camcorder, a closed-circuit television camera, an audio recorder, and/or a digital camera. With respect to the example depicted in FIG. 1, three mobile terminals designated as 1, 2 and 3 may be carried by three different attendees with each mobile terminal configured to capture media content, such as a video recording of at least a portion of the event. While the user equipment of the illustrated embodiment may be mobile terminals, the user equipment need not be mobile and, indeed, other types of user equipment may be used.

Based upon the relative location and orientation of each mobile terminal 10, the field of view of the media capturing module of each mobile terminal may include aspects of the same event. Alternatively, the field of view of the media capturing module of each mobile terminal may include no similar aspects of the same event. In some embodiments, the field of view of the media capturing module of some mobile terminals may include similar aspects of the same event, while the field of view of the media capturing module of other mobile terminals may not include any similar aspects of the same event. As shown in FIG. 1, the mobile terminals 10 or other types of user equipment may provide the captured media content to a server 35 or other media content processing device that is configured to store the user-generated media content, media content, and in some instances to combine the recorded media content by the various media capturing modules, such as by mixing the video recordings captured by video cameras of the mobile terminals. In some embodiments, the server 35 may be configured to store, receive, retrieve, process and/or the like, media content associated with the combined composite media content. For example, the server 35 may be configured to retrieve a map of an event activity from a website corresponding to captured user-generated media content of the event activity. In another example, the server 35 may be configured to retrieve a media content, such as a video recording captured from a helicopter when a user provides a selection indication of an area of interest with a perspective from a higher altitude. As shown in FIG. 1, the server 35 or other media content processing device that collects the recorded media content captured by the media capturing modules may be a separate element, distinct from the user equipment. Alternatively, one or more of the user equipment may perform the functionality associated with the collection, storage and processing, e.g., mixing or otherwise forming a combination of the recorded videos captured by the plurality of the media capturing modules. However, for the purposes of example, but not of limitation, a server or other media content processing device that is distinct from the user equipment including the media capturing modules will be described below.

As shown in FIG. 1, the plurality of mobile terminals 10 or other user equipment may communicate with the server 35 or other media content processing device so as to provide information regarding the recorded videos and/or related information, e.g., context information, in a variety of different manners including via wired or wireless communication links. Indeed, while the example of embodiment illustrates direct communications links between user equipment and the server or other media content processing device, the system of another embodiment may include a network for supporting wired and/or wireless communications therebetween. For example, a camera crew may be capturing video recordings of the event activity with a video camcorder from a helicopter, wherein the video camcorder is configured to communicate via a wireless communication link to a remote media content processing device, such as a composite media content server. According to some embodiments, the server may be connected to a network for supporting wired and/or wireless communications. In another embodiment, the server may be configured to retrieve data corresponding to satellite maps and/or data. For example, the server may be connected to a network, such as the Internet, and configured to retrieve maps and/or satellite images of an event activity. In some embodiments, the server may be configured to search and receive data corresponding to the geographical coordinates of the event activity. In another embodiment, the server may be configured to search and receive data corresponding to the geographical coordinates of the event activity during a particular time period, such as before, during, and/or after an event activity.

In another embodiment of the present invention, the server may be configured to retrieve media content from a network, such as the Internet, corresponding to a particular event activity. For example, the server may be configured to retrieve media content, such as a video recording, stored on a separate remote computing device. In one embodiment, the server may be configured to align the media content stored on the separate remote computing device that has not been previously transmitted to the composite media content server to the user-generated media content currently stored on the composite media content server. Accordingly, the media content stored on the separate remote computing devices may be transmitted to a mobile terminal so as to provide a different view of a selected person of interest and/or selected portion in greater detail. In another embodiment, the server may be configured to provide user-generated media content to the mobile terminal that may provide a different view of a selected person of interest and/or selected portion in greater detail. The server may be further configured to search a network, such as the Internet, for additional data, user-generated media content and/or the like corresponding to the selected person of interest and/or selected portion of the composite media content.

In some embodiments the mobile terminals 10 may be capable of communicating with other devices, such as the mobile terminals of other users, either directly, or via a network. The network may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network. Although not necessary, in some embodiments, the network may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network. By directly or indirectly connecting the mobile terminals 10 and the other devices to the network, the mobile terminals and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the mobile terminals 10 and the other devices may be enabled to communicate with the network and/or each other by any of numerous different access mechanisms. For example, mobile access mechanisms such as universal mobile telecommunications system (UMTS), wideband code division multiple access (W-CDMA), CDMA2000, time division-synchronous CDMA (TD-CDMA), global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network may be a home network or other network providing local connectivity.

The mobile terminals 10 may be configured to capture media content, such as pictures, video and/or audio recordings. As such, the system may additionally comprise at least one composite media server 35 which may be configured to receive any number of user-generated media content from the mobile terminals 10, either directly or via the network. In some embodiments, the composite media server 35 may be embodied as a single server, server bank, or other computer or other computing device or node configured to transmit and/or receive composite media content and/or user-generated media content by any number of mobile terminals. As such, for example, the composite media server may include other functions or associations with other services such that the composite media content and/or user-generated media content stored on the composite media server may be provided to other devices, other than the mobile terminal which originally captured the media content. Thus, the composite media server may provide public access to composite media content received from any number of mobile terminals. Although illustrated in FIG. 1 as a single server, in some embodiments the composite media server 35 comprises a plurality of servers.

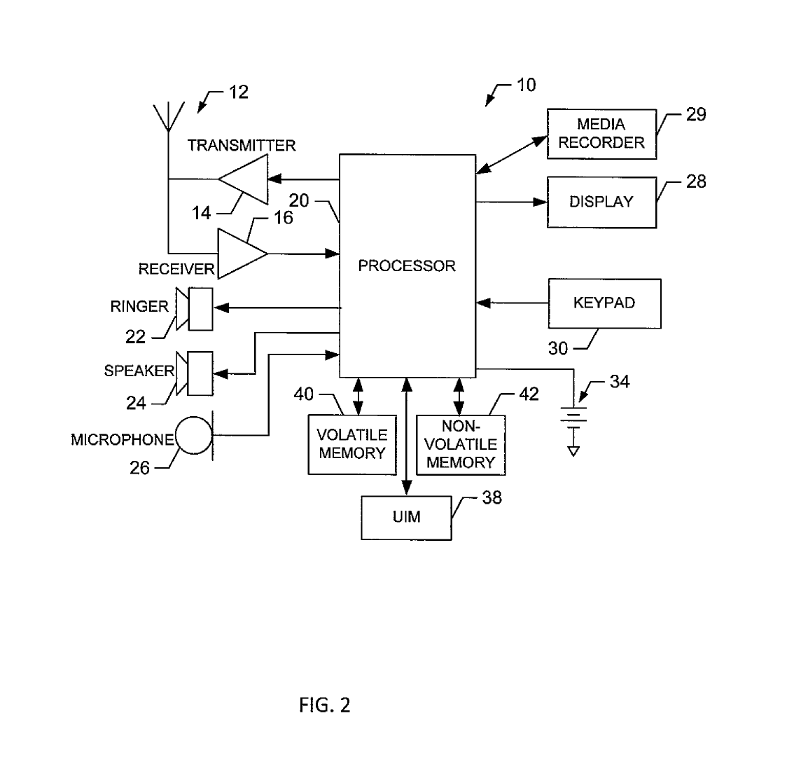

FIG. 2 illustrates a block diagram of a mobile terminal 10 that would benefit from embodiments of the present invention. Indeed, the mobile terminal 10 may serve as the mobile terminal in the embodiment of FIG. 1 so as to capture media content and transmit such content to a composite media server. It should be understood, however, that the mobile terminal 10 as illustrated and hereinafter described is merely illustrative of one type of device that may serve as the mobile terminal and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

As illustrated in FIG. 2, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local area network (WLAN) techniques such as Institute of Electrical and Electronics Engineers (IEEE) 802.11, 802.16, and/or the like. In addition, these signals may include media content data, user generated data, user requested data, and/or the like. In this regard, the mobile user terminal may be capable of operating with one or more air interface standards, communication protocols, modulation types, access types, and/or the like. Some Narrow-band Advanced Mobile Phone System (NAMPS), as well as Total Access Communication System (TACS), mobile terminals may also benefit from embodiments of this invention, as should dual or higher mode phones (e.g., digital/analog or time division multiple access (TDMA)/code division multiple access (CDMA)/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, the media recorder 29, the keypad 30 and/or the like. In addition, the processor 20 may further comprise user interface circuitry configured to control at least some functions of one or more elements of the user interface, such as a media recorder 29 configured to capture media content. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile user terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display. The user input interface may comprise devices allowing the mobile user terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile user terminal.

The mobile terminal 10 may comprise memory, such as a user identity module (UIM) 38, a removable user identity module (R-UIM), and/or the like, which may store information elements related to a mobile subscriber. In addition to the UIM, the mobile user terminal may comprise other removable and/or fixed memory. The mobile terminal 10 may include non-transitory volatile memory 40 and/or non-transitory, non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40, non-volatile memory 42 may include a cache area for temporary storage of data. The memories may store one or more software programs, instructions, pieces of information, data, and/or the like which may be used by the mobile user terminal for performing functions of the mobile terminal. For example, the memories may comprise an identifier, such as an international mobile equipment identification (IMEI) code, capable of uniquely identifying the mobile terminal 10.

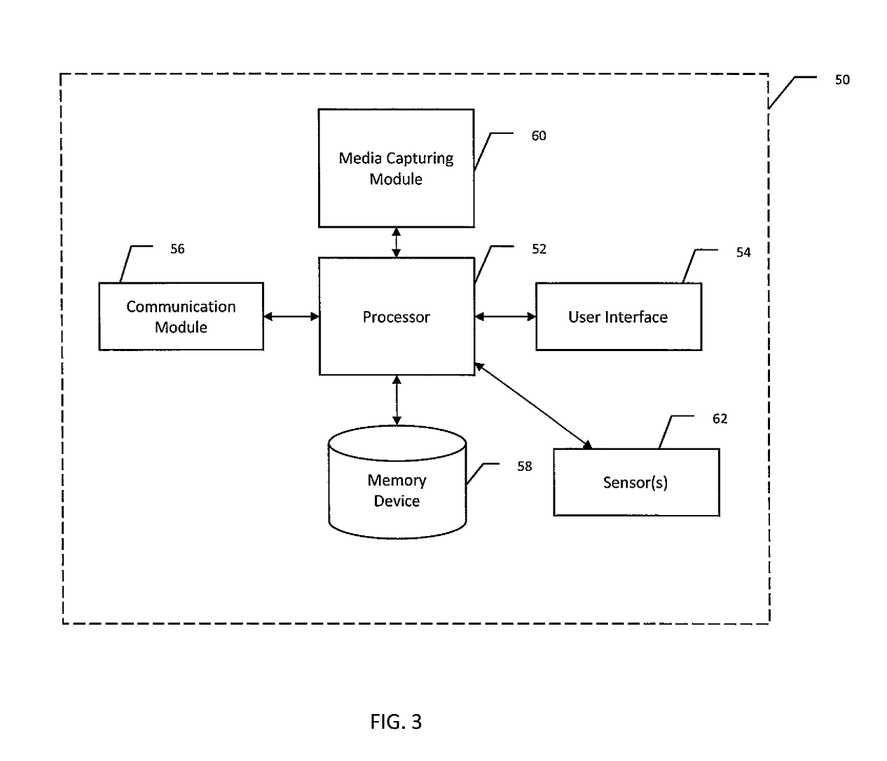

In an example embodiment illustrated in FIG. 3, an apparatus 50 is provided that may be employed by devices performing example embodiments of the present invention. The apparatus 50 may be embodied, for example, as any device hosting, including, controlling, comprising, or otherwise forming a portion of the mobile terminal 10 and/or the composite media server 35. However, embodiments may also be embodied on a plurality of other devices such as for example where instances of the apparatus 50 may be embodied by a network entity. As such, the apparatus 50 of FIG. 3 is merely an example and may include more, or in some cases less, than the components shown in FIG. 3.

With further regard to FIG. 3, the apparatus 50 may include or otherwise be in communication with a processor 52, an optional user interface 54, a communication module 56 and a non-transitory memory device 58. The memory device 58 may be configured to store information, data, files, applications, instructions and/or the like. For example, the memory device 58 could be configured to buffer input data for processing by the processor 52. Alternatively or additionally, the memory device 58 could be configured to store instructions for execution by the processor 52. In an instance in which the apparatus 50 is embodied by a mobile terminal 10, the apparatus 50 may also be configured to capture media content and, as such, may include a media capturing module 60, such as a camera, a video camera, a microphone, and/or any other device configured to capture media content, such as pictures, audio recordings, video recordings and/or the like.

As mentioned above, in some embodiments, the apparatus 50 may be embodied by a mobile terminal 10, the composite media server 35, or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 52 may be embodied in a number of different ways. For example, the processor 52 may be embodied as one or more of various hardware processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. As such, in some embodiments, the processor 52 may include one or more processing cores configured to perform independently. A multi-core processor may enable multiprocessing within a single physical package. Additionally or alternatively, the processor 52 may include one or more processors configured in tandem via the bus to enable independent execution of instructions, pipelining and/or multithreading.

In an example embodiment, the processor 52 may be configured to execute instructions stored in the memory device 58 or otherwise accessible to the processor. The processor 52 may also be further configured to execute hard coded functionality. As such, whether configured by hardware or software methods, or by a combination thereof, the processor 52 may represent an entity (for example, physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor to perform the algorithms and/or operations described herein when the instructions are executed. However, in some cases, the processor 52 may be a processor of a specific device (for example, a user terminal, a network device such as a server, a mobile terminal, or other computing device) adapted for employing embodiments of the present invention by further configuration of the processor by instructions for performing the algorithms and/or operations described herein. The processor 52 may include, among other things, a clock, an arithmetic logic unit (ALU) and logic gates configured to support operation of the processor.

Meanwhile, the communication module 54 may be any means such as a device or circuitry embodied in either hardware, software, or a combination of hardware and software that is configured to receive and/or transmit data from/to a network and/or any other device or module in communication with the apparatus 50. In this regard, the communication module 54 may include, for example, an antenna (or multiple antennas) and supporting hardware and/or software for enabling communications with a wireless communication network. In fixed environments, the communication module 54 may alternatively or also support wired communication. As such, the communication module 54 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication module 54 may include hardware and/or software for supporting communication mechanisms such as BLUETOOTH®, Infrared, UWB, WiFi, and/or the like, which are being increasingly employed in connection with providing home connectivity solutions.

In some embodiments the apparatus 50 may further be configured to transmit and/or receive media content, such as a picture, video and/or audio recording. In one embodiment, the communication module 56 may be configured to transmit and/or receive a media content package comprising a plurality of data, such as a plurality of pictures, videos, audio recordings and/or any combination thereof. In this regard, the processor 52, in conjunction with the communication module 56, may be configured to transmit and/or receive a composite media content package relating to media content captured at a particular event, location, and/or time. Accordingly, the processor 52 may cause the composite media content to be displayed upon a user interface 54, such as a display and/or a touchscreen display. Further still, the apparatus 50 may be configured receive a selection indication of a portion of the composite media content displayed upon a user interface 54. In this regard, the user interface 54 may be configured to receive a selection indication from a user of a particular visual portion, audio portion, and/or the like of the composite media content that the user wishes to view, listen, examine, and/or the like in greater detail.

For example, the apparatus 50 may display the composite media content, such as a video recording of a concert, to a user via the user interface 54. The composite media content may include a video recording of a concert that includes visual images of the event activity, such as the performer, and/or includes visual images of the surroundings of the event activity, such as the crowd located proximate to the performer. While viewing the composite media content on the user interface 54, the user may believe he recognizes a person in the crowd and may provide the apparatus 50 with a selection indication corresponding to the person he believes he recognizes. As such, the apparatus 50, in conjunction with at least the user interface 54, may be configured to receive a selection indication of a portion of a composite media content from a user.

Additionally and/or alternatively, the apparatus 50 may be configured to transmit data corresponding to the selection indication received by the apparatus. Although the apparatus 50 need not include a user interface 54, the apparatus of other embodiments, such as those in which the apparatus is embodied by a mobile terminal 10, may include a user interface. In those embodiments, the user interface 54 may be in communication with the processor 52 to display media content being captured by the media capturing module 60. Further, the user interface 54 may be in communication with the processor 52 to display a selection indication made by a user of a particular media content and/or composite media content at a desired portion of the content. The user interface 54 may also include, for example, a keyboard, a mouse, a joystick, a display, a touch screen, a microphone, a speaker, or other input/output mechanisms.

Alternatively or additionally, the processor 52 may comprise user interface circuitry configured to control at least some functions of one or more elements of the user interface 54, such as, for example, the speaker, the ringer, the microphone, the display, and/or the like. The processor 52 and/or user interface circuitry comprising the processor 52 may be configured to control one or more functions of one or more elements of the user interface 54 through computer program instructions (e.g., software and/or firmware) stored on a memory accessible to the processor 52 (e.g., memory device 58, and/or the like). In another embodiment, the user interface 54 may be configured to record and/or capture media content as directed by a user. Accordingly, the apparatus 50, such as the processor 52 and/or the user interface 54, may be configured to capture media content with a media capturing module 60, such as a camera, a video camera, and/or any other image data capturing device and/or the like.

In one embodiment, the media content that is captured may include a device-specific user identifier that provides a unique identifier as to when the media content was captured and by whom or what device captured the media content. In this regard, the apparatus 50 may include a processor 52, user interface 54, and/or media capturing module 60 configured to provide a user identifier associated with media content captured by the apparatus 50.

The apparatus 50 may also optionally include or otherwise be associated or in communication with one or more sensors 62 configured to capture context information. The sensors may include a global positioning system (GPS) sensor or another type of sensor for determining a position of the apparatus. The sensors may additionally or alternatively include an accelerometer, a gyroscope, a compass or other types of sensors configured to capture context information concurrent with the capture of the media content by the media capturing module 60. The sensor(s) may provide information regarding the context of the apparatus to the processor 52, as shown in FIG. 3. For example, the sensors 62 may provide orientation information corresponding to the direction of the field of view of the media capturing module 60 when the media capturing module captures media content.

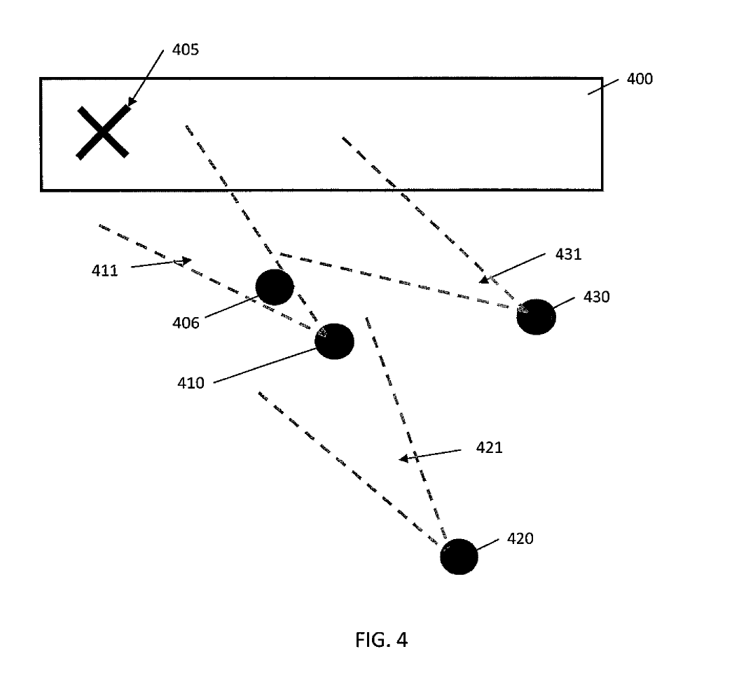

FIG. 4 illustrates a schematic representation of an event attended by a first user 410, a second user 420, a third user 430, and a person of interest 406. According to one embodiment, the first user 410, second user 420, and third user 430 may be focusing on and/or capturing media content of a target area of interest 405 on a stage 400. In some embodiments, the target area of interest 405 may include a performer, artist, and/or the like. As such, the mobile terminal of the first user 410 may have a field of view 411, the mobile terminal of the second user may have a field of view 421, and the mobile terminal of the third user 430 may have a field of view 431. Additionally and/or alternatively, the mobile terminals of the first user 410, second user 420, and third user 430 may be configured to provide context information such as information corresponding to the mobile terminal location, orientation, direction of the field of view, and/or the like when the mobile terminal captures media content. As such, the composite media content server may be configured to receive the location data and/or context data from any one of the mobile terminals, and may be further configured to determine the location, direction of the field of view, orientation and/or the like of the mobile terminals when the mobile terminals captured a particular media content. In some embodiments the context data may be included with the media content as metadata and/or the like. According to some embodiments of the present invention, each of the mobile terminals of the first user 410, the second user 420, and the third user 430 may transmit a media content to the composite media content server, and may be further configured to receive a composite media content from the composite media content server. The composite media content may include any combination of portions of media content captured by any one of the mobile terminals of the first user 410, the second user 420, and/or the third user 430. Although only a first user, 410, a second user 420, and a third user 430 are shown in FIG. 4 as capturing media content, any number of users may capture media content with a mobile terminal and/or transmit media content to a composite media content server.

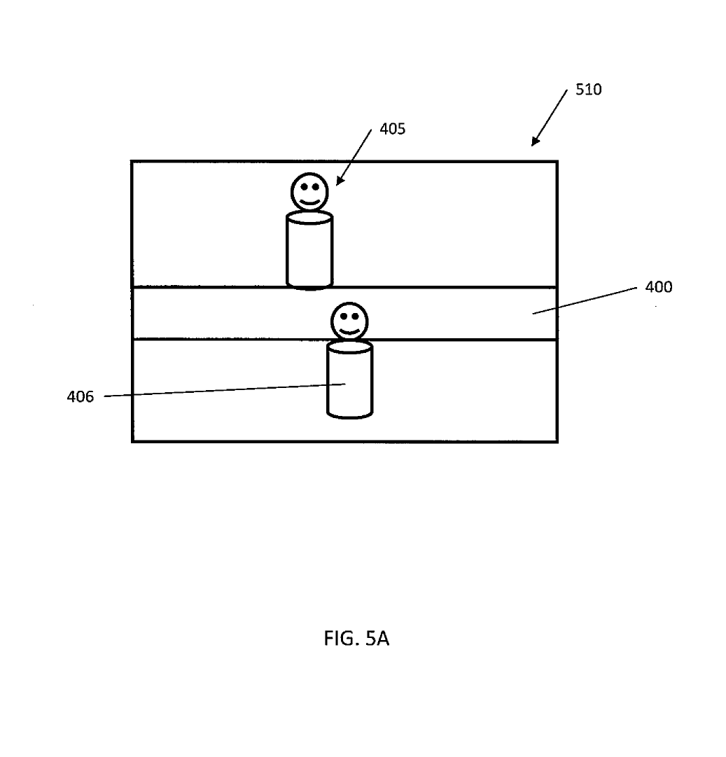

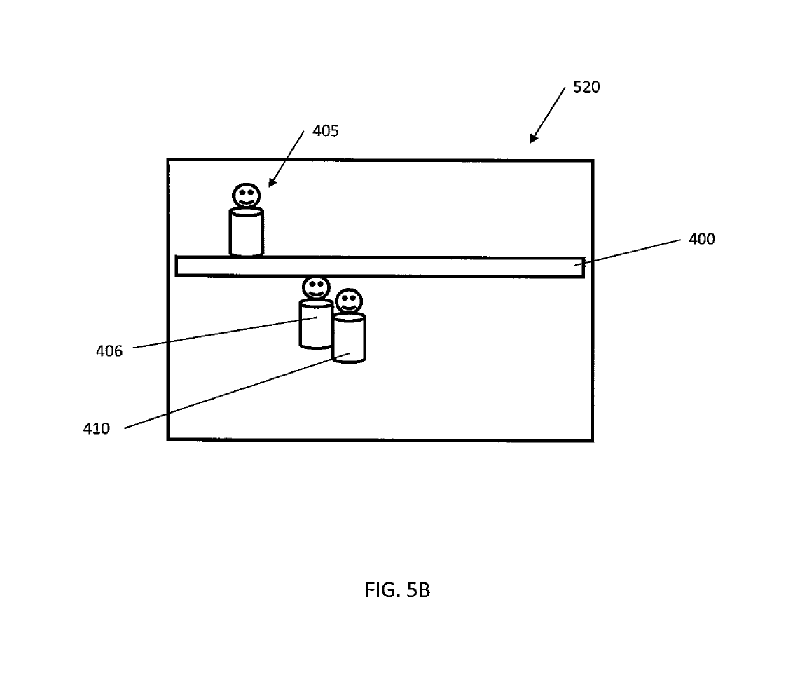

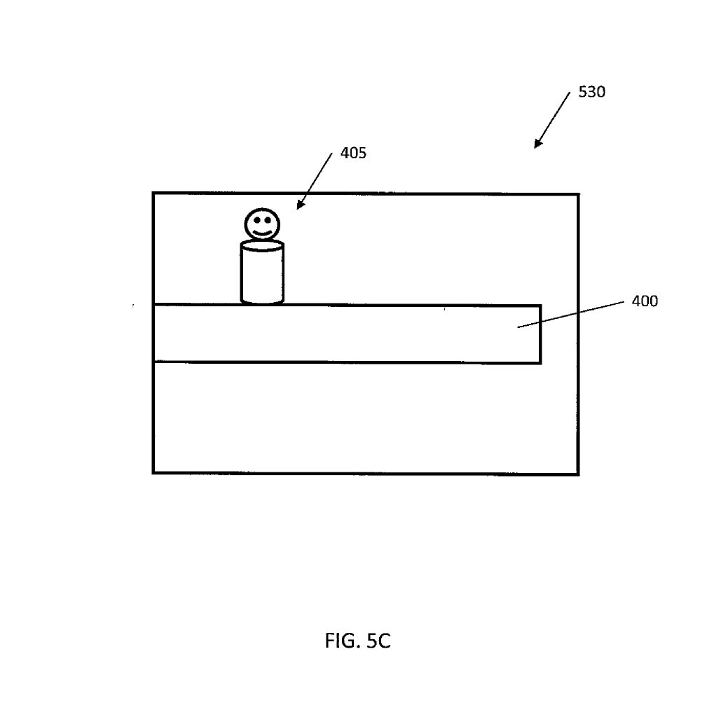

Referring now to FIGS. 5A, 5B, and 5C, according to some embodiments of the invention, a mobile terminal may include a user interface, such as a display, providing for a composite media content to be displayed thereon. Additionally and/or alternatively, the mobile terminal of the first user 410, the second user 420, and the third user 430 may include a user interface configured to display the respective media content, such as a visual recording, as a media capturing module of the respective mobile terminals capture the media content. For example, FIG. 5A illustrates a user interface 510 of the mobile terminal of a first user as the first user captures media content. Accordingly, the user interface 510 of the mobile terminal used by the first user 410 may be configured to display the media content as the media capturing module of the first user's 410 mobile terminal captures the media content. As such, the user interface 510 may be configured to display a media content including a stage 400, a target area of interest 405, and a person of interest 406 as provided by the field of view 411 of the mobile terminal of the first user 410. FIG. 5B illustrates a user interface 520 of the mobile terminal of a second user 420 as the second user captures media content. As such, the user interface 520 may be configured to display a media content comprising a stage 400, a target area of interest 405, the first user 410, and a person of interest 406 as provided by the field of view 421 of the mobile terminal of the second user. FIG. 5C illustrates a user interface 530 of the mobile terminal of a third user 430 as the third user captures media content. As such, the user interface 530 may be configured to display a media content comprising a stage 400 and a target area of interest 405 as provided by the field of view 431 of the mobile terminal of the third user.

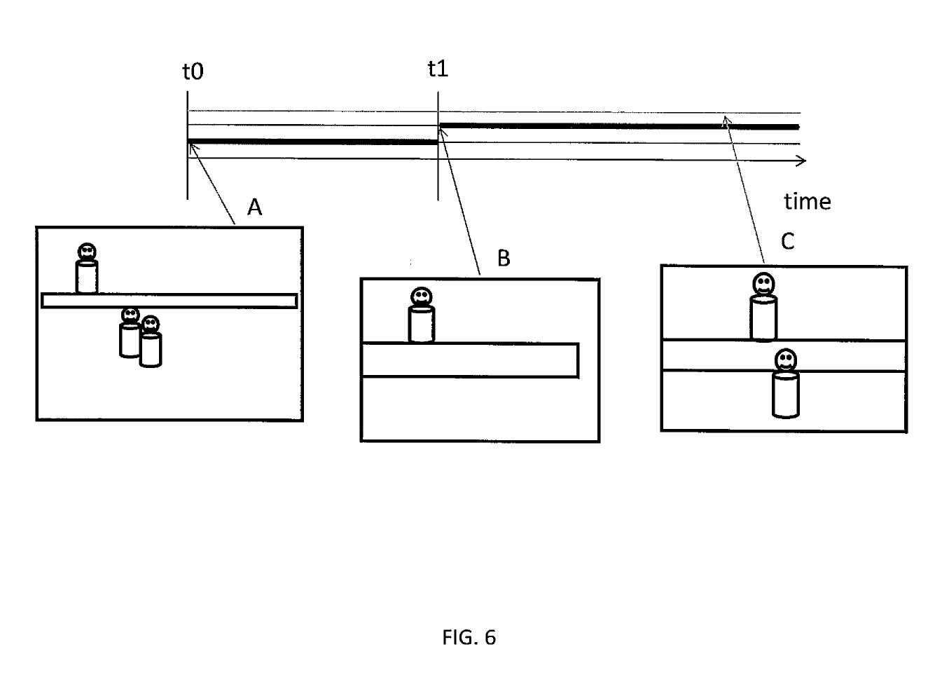

In some embodiments, the mobile terminals of the first user 410, second user 420, and third user 430 may be configured to provide, transmit, and/or receive media content to a composite media content server. According to some embodiments, the composite media content server may be configured to store and/or process media content so as to combine media content captured by different users into a single composite media content. FIG. 6 illustrates a schematic representation of a composite media content containing portions of media content captured by mobile terminals. In some embodiments, the composite media content may include portions of all of the media content captured by any number of mobile terminals. In other embodiments, the composite media content may include portions of only a selected number of media content captured by the respective mobile terminals. As such, FIG. 6 illustrates a composite media content containing portions of media content captured by the mobile terminals of a second user 420 and a third user 430. Specifically, the first portion of the composite media content contains portions of media content A captured by the second user 420 from t0 to t1, and the second portion of the composite media content includes portions of media content B captured by the third user 430 from t1 onwards. As such, a user may view the composite media content via a mobile terminal and select the person of interest 406 as part of a selected portion the user wishes to view in greater detail. In some embodiments, the composite media server may be configured to provide the user with a media content, such as the media content captured by the first user 410, which may have greater detail of the person of interest 406. In some embodiments, a user may select a portion of the composite media content and request media content corresponding to the selected portion for a different period of time. Accordingly, the composite media content server may be configured to search and/or retrieve media content providing greater detail of the selected portion of the composite media content at a period of time before and/or after the time period shown by composite media content. For example, a user may select a portion of a composite media content, such as an audio recording of a particular song at a concert, and request media content corresponding to an audio recording 10 minutes prior to the particular song.

As shown in FIG. 6, a composite media content may include media content. Although FIG. 6 illustrates a composite media content comprising user-generated media content, one of ordinary skill in the art may appreciate that the composite media content may include professionally-captured media content, video recordings captured by closed-circuit television cameras, and/or any other media content. Additionally and/or alternatively, the composite media content server may be configured to provide a user with media content captured, recorded, and/or created from any source. Specifically, FIG. 6 illustrates the composite media content includes media content A, B captured by a first user and a second user respectively, but does not include media content C. In some embodiments, the composite media content server may be configured to provide media content C when a user provides a selection indication including a person of interest.

In some embodiments, the composite media content server may be configured to provide a media content to a mobile terminal based at least in part on a selection indication provided by a user and/or the media content available to the composite media content server. The user may provide a selection indication corresponding to a person of interest at a particular time, such as 8:35 PM. According to some embodiments, the composite media content server may be configured to provide a media content corresponding to the selected portion of the composite media content at a different time than initially requested by the user in the selection indication. For example, the composite media content server may be able to provide media content providing greater detail of the person of interest only at the time periods of 8:15 PM to 8:30 PM and from 8:45 PM to 9:00 PM because no media content exists for the selected portion at 8:35 PM. As such, the composite media content server may be configured to provide the media content providing greater detail of the person of interest available to the person of interest that do not correspond to the time period of the selection indication.

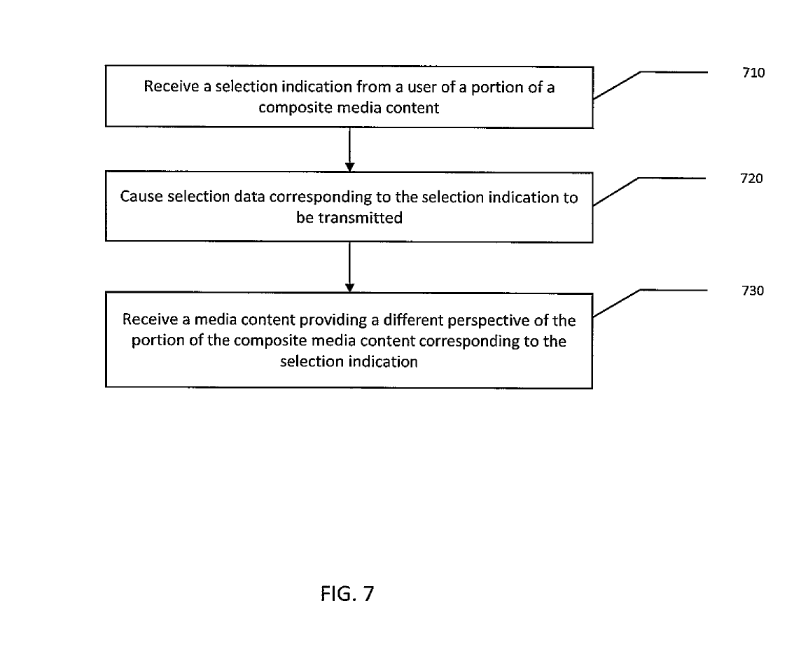

Referring now to FIG. 7, the operations performed by a method, apparatus, and computer program product of an example embodiment will be described herein. It will be understood that each block of the flowchart, and combinations of blocks in the flowchart, may be implemented by various means, such as hardware, firmware, processor, circuitry and/or other devices associated with execution of software including one or more computer program instructions. For example, one or more of the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

In this regard, the apparatus 50 embodied by the mobile terminal, may include means, such as the processor 52, the media capturing module 60, the user interface 54, and/or the memory device 58 for capturing a media content of an event activity. For example, the apparatus may be configured to capture media content, such as a video recording, of an event activity and/or target area of interest. Additionally and/or alternatively, the apparatus 50 may be configured to capture context information regarding the location, orientation, and/or direction of the field of view of the apparatus when the media content is being captured. Additionally and/or alternatively, the apparatus 50 may include means, such as the processor 52, the communication module 56, and/or the memory device 58 for transmitting media content to a composite media server. Additionally and/or alternatively, the apparatus 50 may include means, such as the processor 52, the communication module 56, and/or the memory device 58 for transmitting data corresponding to contextual information of the apparatus, such as the location of the apparatus, the direction of the field of view of the apparatus, and/or the like, to a remote computing device. In some embodiments, the apparatus 50 may include means, such as the processor 52, the communications module 56, and/or the memory device 58 for receiving composite media content from a remote computing device, such as a composite media content server.

Further, the apparatus 50 may include means, such as the processor 52, the communications module 56, memory device 58, and/or user interface 54 for causing the composite media content to be displayed. For example, the user interface 54 may be embodied as a touch display configured to display a composite media content received by the apparatus from a composite media content server. Additionally and/or alternatively, the user interface 54 may be further configured to receive an input from a user, such as a touch input, corresponding to a selection of a portion of the composite media content, which may comprise a video recording that includes a compilation of media content captured from a number of different mobile terminals. See block 710. According to some embodiments of the present invention, a user may view the composite media content on the user interface of the apparatus and see a person in the crowd that he may recognize in the video recording. In some embodiments, the user may wish to view other media content that may include portions of media content of the person of interest in greater detail than the remainder of the composite media content. As such, the user may provide the user interface with an input, such as touch input, selecting the person of interest in the crowd.

According to some embodiments, the apparatus 50, may be configured to transmit data corresponding to the selection indication to a remote computing device, such as a composite media content server. See block 720. For example, the composite media content may include a visual recording of a target area of interest and a person of interest in the crowd that may be out of focus, zoomed out, unclear, and/or the like. As such, the user may provide the user interface with a touch input outlining the person of interest in the composite media content so as to obtain any media content corresponding to the person of interest that provides greater detail. The target area of interest may be defined in other manners, such as by an identification of the frame number of the image from which the user made the selection as well as the coordinates of the target area of interest within the respective frame. In some embodiments, the apparatus may transmit data corresponding to the selected portion to a composite media content server configured to store media content of the same event activity. As such, the composite media content server may be configured to receive the selected portion and determine if additional media content captured at the event activity may include a different view of the person of interest and/or selected portion in greater detail.

In some embodiments, a user may wish to hear an audio track of an event activity recorded from a certain position. Accordingly, the user may provide the apparatus with a selection indication of the desired audio recording location to which the user wishes to listen. For example, a user at a concert may wish to hear an audio recording captured proximate to a particular band member playing a particular instrument. The composite media content may include a visual recording with an audio track captured from a considerable distance from the particular band member playing the specific instrument. As such, the user may provide the user interface with a selection of the band member and may further provide an indication that the user wishes to hear an audio track recorded from a position proximate to the band member playing the particular instrument. Accordingly, the apparatus 50 may be configured to transmit data corresponding to the selection indication comprising the desired audio recording location to a composite media content server.

In some embodiments of the present invention, the apparatus 50 may include means, such as the processor 52, the communication module 56, and the memory 58 for receiving a media content providing a different perspective of the portion of the composite media content corresponding to the selection indication. See block 730. For example, the composite media content server may be configured to store a plurality of media content corresponding to a particular event activity. Accordingly, a user may provide an apparatus with a selection indication of a portion of the media content that the user wishes to view, listen, review and/or the like in greater detail. For example, an apparatus may include means for displaying a composite media content, such as the composite media content illustrated in FIG. 6. The user may view the composite media content and believe they recognize a person of interest 406 in the composite media content. However, the person of interest 406 in the composite media content may not be displayed in great detail as the portion of composite media content may have included media content of the person of interest from a far distance. Accordingly, the user may provide the apparatus with a selection indication corresponding to the person of interest 406, and the apparatus may further be configured to transmit data corresponding to the selection indication to a composite media content server. As such, the composite media content server may be configured to determine if other media content exists that may provide a different perspective of the portion of the composite media content corresponding to the selection indication.

In some embodiments, the composite media content server may be configured to store media content and data corresponding to the context information of when the media content was captured. For example, the context information data may include global positioning system data, orientation data, timestamp data, and/or the like. As such, the composite media content server may be configured to determine the direction and/or orientation of the field of view of an apparatus capturing media content. Accordingly, when a composite media content server receives a selection indication data corresponding to a person of interest 406, the composite media content server may be configured to transmit a media content providing a different perspective of the portion of the composite media content corresponding to the selection indication. For example, when a user views a composite media content, as illustrated in FIG. 6, comprising portions of media content captured by a second user 420, the user may provide a selection indication to the apparatus corresponding to the person of interest 406, whom the user believes they recognize but cannot determine because the great distance between the second user and the person of interest when the media content was captured. In some embodiments, the composite media content may not include media content having a different perspective of the portion of the composite media content corresponding to the selection indication. In other embodiments, the composite media content may include media content having a perspective of the person of interest 406 in greater detail. Accordingly, the composite media content server may be configured to provide the user with a media content captured by the first user 410 that provides a closer picture of the person of interest 406. As such, the apparatus 50 may include means, such as the processor 52, the communication module 56, the memory device 58, and the user interface 54 for receiving the media content captured by the first user 410 and displaying the media content captured by the first user 410 that provides a closer view of the person of interest 406.

According to some embodiments, the selection indication may further include a selection of a portion of a composite media content and a time interval, time stamp, and/or other temporal marker. For example, a user may provide a selection indication to a mobile terminal comprising a person of interest 406 at a particular point in time. According to some embodiments, a user may provide a selection indication to a mobile terminal comprising a portion of an audio recording at a particular point in time. In some embodiments, the composite media content server may be configured to provide the user with a first media content that provides greater detail of the selected portion by analyzing, matching, and/or retrieving media content based at least in part on matching a user's selected portion with the first media content. For example, the composite media content server may be configured to provide the user with a first media content that provides greater detail of the selected portion comprising a person of interest 406 at a first time based at least in part on facial recognition technology. According to some embodiments, the composite media content server may be configured to provide the user with a first media content based at least in part on matching an audio track of the selected portion to an audio track of the first media content. The user may further provide a selection indication to the composite media content server for the person of interest at a later point in time than the media content previously transmitted to the mobile terminal by the composite media content server. In some embodiments, the first media content previously transmitted to the mobile terminal of the user comprising greater detail of the selected portion may not exist at the later point in time. For example, the user capturing the first media content previously transmitted by composite media content server to the mobile terminal of the user who provided the selection indication may have displaced and/or stopped recording the media content. As such, the composite media content server may be configured to determine that a second media content provides further detail of the selected portion comprising the person of interest. Additionally and/or alternatively, the composite media content server may be configured to transmit the second media content that provides greater detail of the selection portion comprising the person of interest to the mobile terminal of the user.

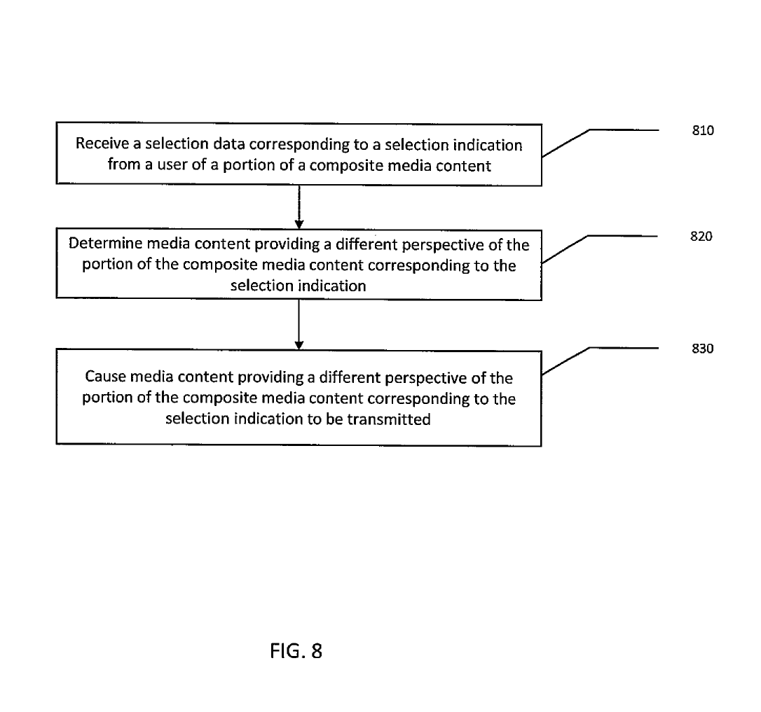

Referring now to FIG. 8, the operations performed by a method, apparatus, and computer program product of an example embodiment will be described herein. It will be understood that each block of the flowchart, and combinations of blocks in the flowchart, may be implemented by various means, such as hardware, firmware, processor, circuitry and/or other devices associated with execution of software including one or more computer program instructions. For example, one or more of the procedures described above may be stored by a memory device and executed by a processor of a remote computing device, such as a composite media content server. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

In this regard, an apparatus embodied by a remote computing device, such as a composite media content server, may include means, such as a processor, a memory device, and/or a communication module for receiving data corresponding to a selection indication of a portion of a composite media on a mobile terminal. See block 810. For example, the remote computing device may be configured to receive data corresponding to a selection indication of a person displayed in an attending crowd at an event activity of a composite media content, such as a video recording. Although embodiments described herein relate to a composite media content corresponding to an event activity, one skilled in the art may appreciate that embodiments of the present invention may be used with composite media content corresponding to any number of activities. For example, a remote computing device may be configured to receive and store media content, such as video recordings provided by closed circuit television cameras of a particular location. In one embodiment of the present invention, the remote computing device may be configured to receive a selection indication of a particular portion of the closed circuit television camera video recording, such as when the closed circuit television camera video recording captures a person committing a crime. For example, the selection indication may be a portion of the video recording focusing on the face of the criminal. Accordingly, the remote computing device may be configured to determine additional media content providing a different perspective of the face of the criminal that provides greater detail.

According to some embodiments, the remote computing device may be configured to determine media content providing a different perspective of the portion of the composite media content corresponding to the selection indication. See block 820. For example, the composite media content may include a visual recording of a target area of interest and a portion of the composite media that a user wishes to select for greater detail, information and/or the like. Accordingly, a user may be able to select a portion of the composite media content and cause an apparatus, such as a mobile terminal, to transmit the selection data corresponding to the selected portion of the composite media to the composite media content server. In some embodiments, the composite media content server may be configured to determine, at least in response to the selection data, media content providing a different perspective of the portion of the composite media content corresponding to the selection indication. In one embodiment, the composite media content server may determine another media content having contextual data corresponding to the media content was captured closer to the selected portion of the composite media content.

According to one embodiment, the composite media content server may be configured to cause media content providing a different perspective of the portion of the composite media content corresponding to the selection indication to be transmitted. See block 830. In this regard, the composite media content server may be configured to determine that another media content was captured at a closer distance to the selected portion of the composite media content. Further, the composite media content server may be configured to transmit the media content to an apparatus, such as a mobile terminal, in response to the selection data provided by the mobile terminal.

Some advantages of embodiments of the present invention may include increased value of user-generated media content of an event activity. While some user-generated media content of a particular event activity may include portions that include blocked and/or obstructed views of the target area of interest, the user-generated media content may have increased value for other individuals wishing to inspect a portion within the field of view of the media content that included the blocked and/or obstructed view of the target area of interest. In addition, additional advantages may include the increased distribution of composite media content, as greater number of users may wish to view a composite media content configured to provide additional media content containing differing perspectives and/or views.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-21. (canceled)

22. An apparatus comprising at least one processor and at least one memory including computer program code, the at least one memory and the computer program code configured to, with the processor, cause the apparatus to:
receive a selection indication from a user of a portion of a composite media content;
cause selection data corresponding to the selection indication to be transmitted; and
receive media content providing a different perspective of the portion of the composite media content corresponding to the selection data.

23. The apparatus of claim 22, wherein receiving media content providing a different perspective of the portion of the media content comprises receiving media content not present in the composite media content.

24. The apparatus of claim 22, wherein the selection data is transmitted to a composite media content server.

25. The apparatus of claim 22, wherein the media content includes an audio media content.

26. The apparatus of claim 22, wherein the media content includes a visual media content.

27. The apparatus of claim 22, wherein the composite media content comprises portions of maps, video recordings, audio recordings, and/or pictures.

28. The apparatus of claim 22, wherein the composite media content comprises portions of user-generated media content.

29. A method comprising:
receiving a selection indication from the user of a portion of a composite media content;
causing selection data corresponding to the selection indication to be transmitted; and
receiving media content providing a different perspective of the portion of the composite media content corresponding to the selection indication.

30. The method of claim 29, wherein receiving media content providing a different perspective of the portion of the media content comprises receiving media content not present in the composite media content.

31. The method of claim 29, wherein the selection data is transmitted to a composite media content server.

32. The method of claim 29, wherein the media content includes an audio media content.

33. The method of claim 29, wherein the media content includes a visual media content.

34. The method of claim 29, wherein the composite media content comprises portions of maps, video recordings, audio recordings, and/or pictures.

35. The method of claim 29, wherein the composite media content comprises portions of a plurality of user-generated media content.

36. A computer program product comprising at least one non-transitory computer-readable storage medium having computer-readable program instructions stored therein, the computer-readable program instructions comprising program instructions configured to cause an apparatus to perform a method comprising:
receiving a selection indication from the user of a portion of a composite media content;
causing selection data corresponding to the selection indication to be transmitted; and
receiving media content providing a different perspective of the portion of the composite media content corresponding to the selection indication.

37. The computer program product of claim 36, wherein receiving media content providing a different perspective of the portion of the media content comprises receiving media content not present in the composite media content.

38. The computer program product of claim 36, wherein the selection data is transmitted to a composite media content server.

39. The computer program product of claim 36, wherein the media content includes an audio media content.

40. The computer program product of claim 36, wherein the media content includes a visual media content.

41. The computer program product of claim 36, wherein the composite media content comprises of maps, video recordings, audio recordings, and/or pictures.
